(19) United States
(12) Patent Application Publication
(10) Pub. No.: US 2008/0098604 A1
(43) Pub. Date: May 1, 2008

(54) HIPPA HELPER PHARMACY SPATULA

(76) Inventors: Clark Levi, Ocean Springs, MS (US); Kenneth Smith, Ocean Springs, MS (US)

Correspondence Address: AUSTIN BONDERER, ESQ., 644 BROOKWOOD ST., BREA, CA, 92821, US

(21) Appl. No.: 11/866,623

(22) Filed: Oct. 3, 2007

Related U.S. Application Data
(60) Provisional application No. 60/827,921, filed on Oct. 3, 2006.

(51) Int. Cl. B26B 1/02; B24D 15/00

(52) U.S. Cl. 30/155; 15/236.07

(57) ABSTRACT

A HIPPA compliance device used by an individual in the distribution of prescription medication having the ability to render labels, containing patient information, of used prescription containers illegible rendering the used prescription containers in compliance with HIPPA. The HIPPA compliance device comprises a tool that has means for rendering labels of prescription medication containers illegible in response to relative movement between the invention and the prescription container. Some embodiments include the means for rendering the labels illegible in the or connected to the handle of a spatula. In other embodiments, the means for rendering the labels illegible are independent of a spatula.

### RELATED APPLICATIONS

This application claims benefit of U.S. Provisional Application No. 60/827,921, filed Oct. 3, 2006, the disclosure of which is incorporated herein by reference.

### FIELD OF THE INVENTION

The instant invention relates to tools used by pharmacist or any other individual in the distribution of prescription medicine to anyone covered under the Health Insurance Portability and Accountability Act (HIPPA) privacy rule. The use of the toll will render the used pharmaceutical container HIPPA complient.

### BACKGROUND OF THE INVENTION

With the recent implementation of the Health Insurance Portability and Accountability Act (HIPPA) privacy rule (which took effect on Apr. 14, 2003), it is now incumbent upon medical professionals to protect the medical information of their patients. Medical professional may now be held liable for any unauthorized release of protected medical information. Therefore, it is now essential for medical professionals to prevent disclosure of their patients' information. This was never a major concern until the passage of the act.

Under the HIPPA privacy rule, pharmacists now have a duty to safeguard patient information. One way that pharmacists' inadvertently release their patients' information is on the discarded used pharmaceutical containers, such as pill bottles given to the pharmacist by the patient showing that the patient is entitled to a prescription refill. Previously, it was accepted practice to dispose of the containers in the common trash without any treatment. Currently if pharmacists want to make use of the common trash, the pharmacists must render the information located on the container labels illegible or be subject to legal action. Otherwise, pharmacists must use some other means to dispose of their used pharmaceutical containers, and those other means can be much more expensive. Therefore, because of the passage of HIPPA, there is a newly created need for a device that removes the protected information from pharmaceutical containers that is also convenient, easy to use and effective. This need never existed before the passage of HIPPA privacy rule. The HIPPA Helper Pharmacy Spatula presents a viable solution for the newly created responsibility for pharmacists and the pharmacies.

### SUMMARY OF THE INVENTION

The present invention provides a convenient and easy way for pharmacists to remove patient information contained on pharmaceutical containers. The invention may include or be attached to a pharmaceutical spatula, currently used by pharmacies to count pills for distribution to patients. The difference is that the invention includes a means to render labels illegible in convenient and effective manner while still remaining a valuable pharmacy tool.

In one embodiment of the invention, the tool and the spatula are integral and part of the same blade. The tool end is housed inside the spatula handle. The blade swivels about the handle when the tool is to be employed.

The tool will have means to remove, destroy, mark or any other means to render the labels illegible; therefore render the containers HIPPA compliant.

In another embodiment, the spatula itself is flexible with one or more label removing means.

In another embodiment, a strap with label removal means may be attached to a spatula.

The reason why this invention is needed by pharmacists is that people, when obtaining a refill of their prescription, return their pharmaceutical containers, e.g. pill bottles, to the pharmacist that state the patient is entitled to a refill of their prescription. Once a pharmacist receives the bottle, the pharmacist are required to dispose of the bottle properly or expose themselves to potential liability under HIPPA. Once the pharmacist receives the container, the invention allows the pharmacist to efficiently sort/count out pills and easily render the label illegible. The advantage of the tool and the spatula in the same device is that pharmacists are better able to protect themselves from liability while not cluttering up the pharmacists' counter. For example, when it is busy at a pharmacy, it is very easy for a pharmacist to put a container down or off to the side with the intention of destroying the label later. However, if the pharmacist forgets and that container happens to make it to the trash, e.g. an assistant or janitor in an attempt to clean throws the container in the trash, the pharmacist is now liable because a violation of HIPPA has occurred. The invention disclosed herein will allow the pharmacist to remove the protected information in a quick convenient manner while not veering from the regular system of filling prescriptions.

### BRIEF DESCRIPTION OF THE DRAWINGS

FIGS. 1-11 shows the first embodiment of the invention;

FIG. 12 shows how the first embodiment is used;

FIG. 13 shows a second embodiment of the invention; and

FIG. 14 shows a third embodiment of the invention.

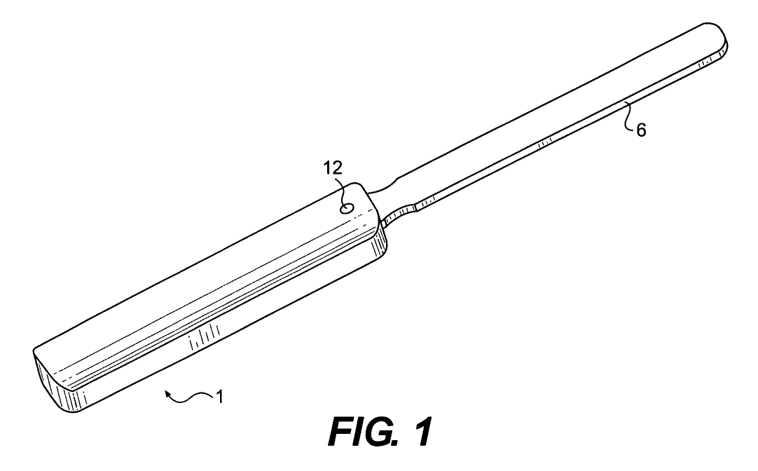

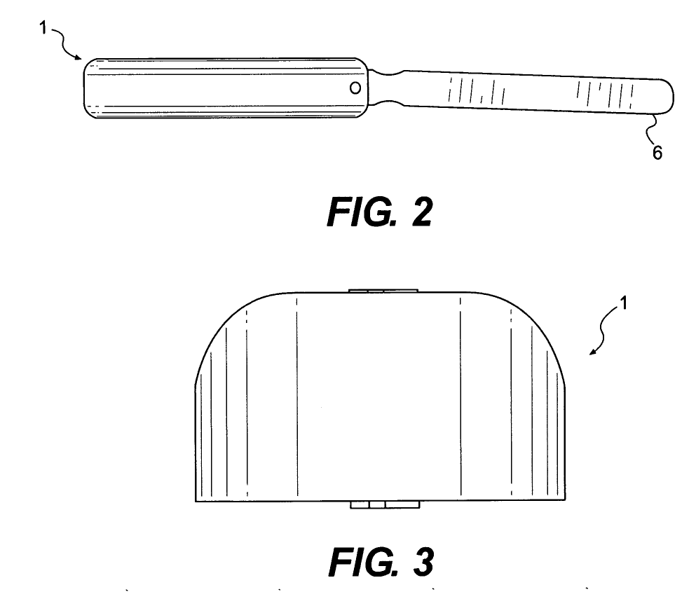

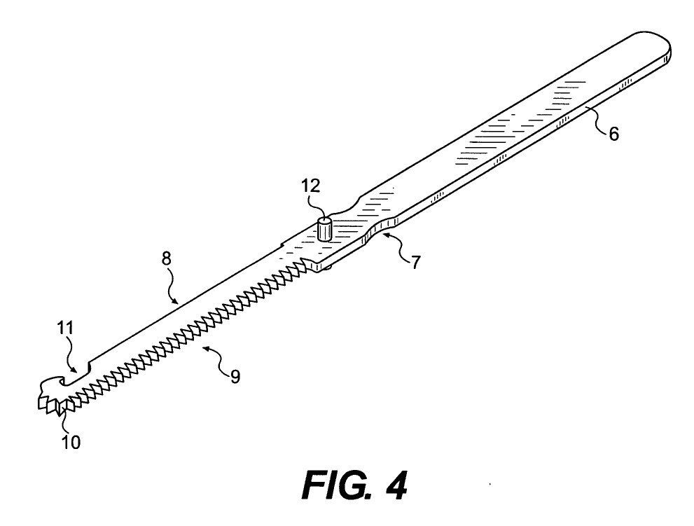

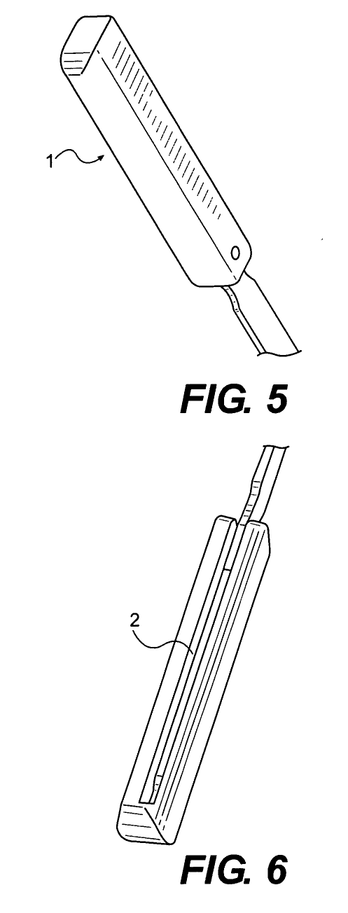

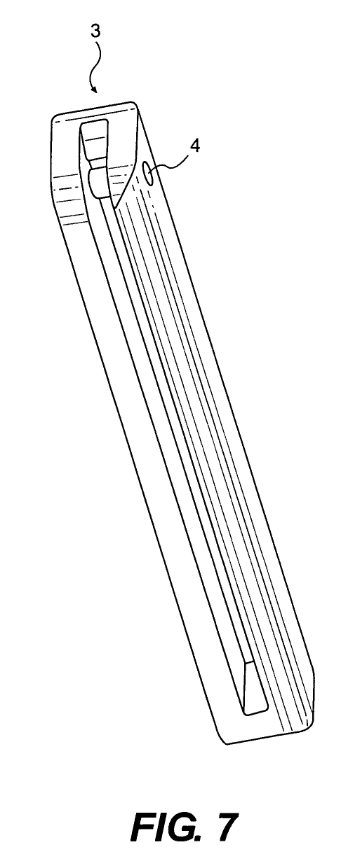

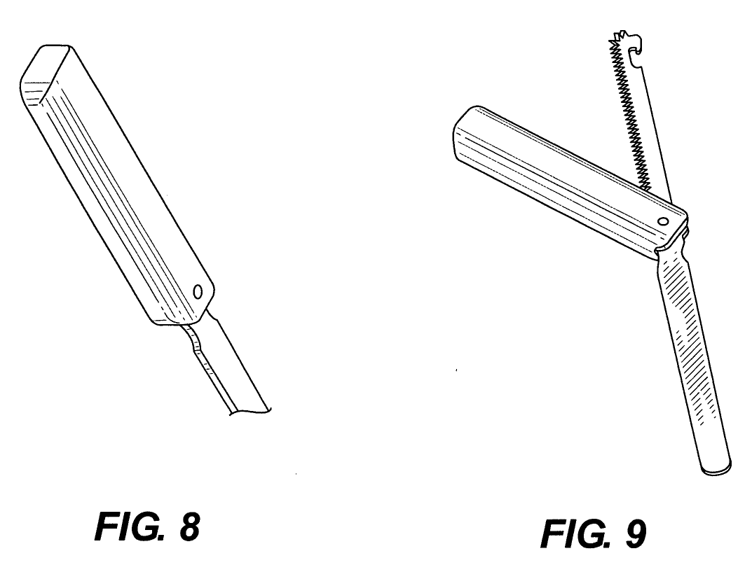

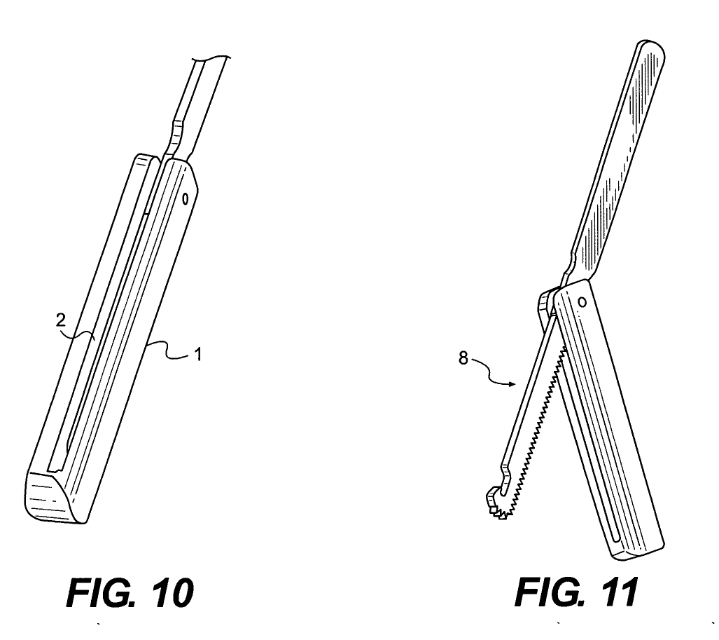

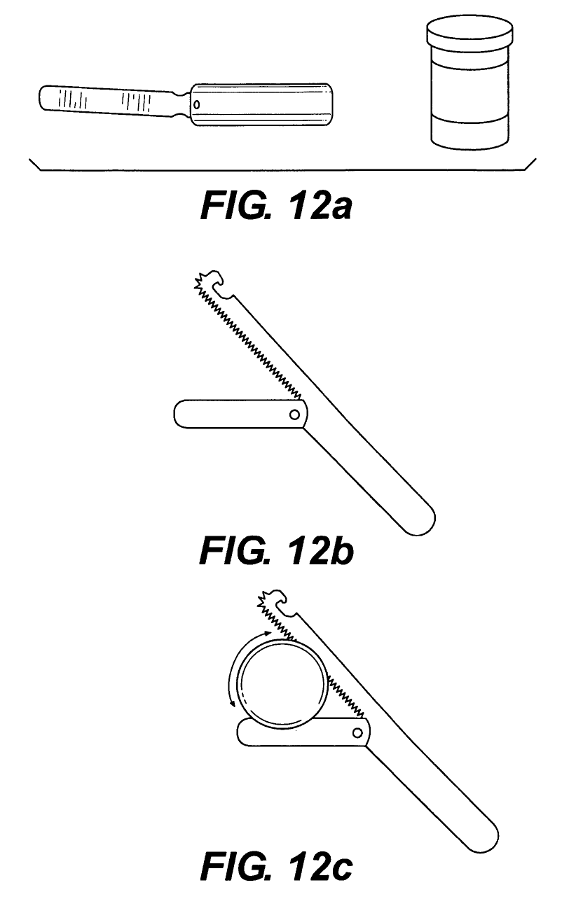

### DETAILED DESCRIPTION OF THE DRAWINGS

In the first embodiment, the HIPPA Compliance Device comprises of a handle 1 and a blade 5. The handle 1 comprises a slit 2, a stop 3 and a connector receptacle 4. The blade 5 comprises a spatula 6 and a tool 8. The spatula can have rounded grips 7. The tool 8 has an edge 9 that will render the label illegible and a tip 10 that is capable of piercing tamper resistant seals. The tip 10 may have a hook 11 capable of ensnaring the packing material used in pharmaceutical containers, e.g. cotton. A connector 12 provides a connection between the handle 1 and the blade 5. While it is shown that the connection between the handle 1 and the blade 5 is in the form of a pin and a hole, any connection that allows for a secure connection while allowing relative movement between the two members is contemplated.

By way of example, a serrated edge is shown in the drawings, but the edge 9 can comprise of any means which would render the label illegible. Those means include an edge capable of removing portions of or all of the label such as those resembling a file, a rasp, sandpaper and/or any surface that would cause friction between the edge and the label such that the label will be rendered illegible. The edge 9 can also comprise of a means that would deposit a substance upon the label, such as ink, water, detergent, and/or a substance that would act to dissolve the label. The edge can have any combination of single or multiple friction means and/or single or multiple substance deposit means.

The edge 9 can also have one or more curves that correspond to standardized pharmaceutical containers. The curves will increase the surface contact between the labels and the blade 9.

While the tool is shown with one edge 9, both sides of the tool can have an edge 9.

With the current embodiment, a pharmacist will use the spatula 6 to separate and count out pills and in any way they would use a typical spatula when the invention is the closed position. However, when the invention is in the open position, the tool 8 is exposed, and the tool provides pharmacists a convenient and effective way to render the labels on pharmaceutical containers illegible either by means of friction, depositing of material or a combination of both.

Often a pharmacist will receive a used pharmaceutical container when a patient wants to refill a prescription for pills. The pharmacist will take the bottle and determine what pills need to be distributed. Typically, the pills required by the prescription come to the pharmacist in large numbers in large pill containers called vials. These vials have seals and typically packing material. In using the current invention, the pharmacist will rotate the blade 5 until in comes into contact with the stop 3 or until a desired position is obtained. This will expose the tool 8 with its edge 9, tip 10 and hook 11. The tip 10 is used to pierce the seal on the vials. The hook 11 is then used to hook the packing material located inside the vial. After pouring the pills on a counting tray and rotating the blade 5 so that the tool 8 is housed within the handle 1, the pharmacist will use the spatula 6 to count and separate the pills. After filling the prescription, the pharmacist will then rotate the blade again to expose the tool 8 and the edge 9. The pharmacist will then place the used/returned pharmaceutical container in between the handle 1 and the tool 8 so that the edge 9 and label are in contact. The pharmacist can apply pressure by pushing the tool against the bottle that is against the handle 1. The pharmacist will then cause relative movement between so that the label will become illegible.

In the case of tool with several curved edges on the tool, the pharmacist would place the bottle in the curved section that has the most similar radius of the used pharmaceutical container to remove the label.

While a pill bottle has been described by way of example, the invention can be used on anything that has a label.

In an alternative embodiment, the tool need not have a spatula. A tool 8 that is foldable into a handle 1 would be extremely useful to a pharmacist.

The invention in all of the embodiments can also have a lock that is capable of securing the tool 8 in the open, closed or any position there between.

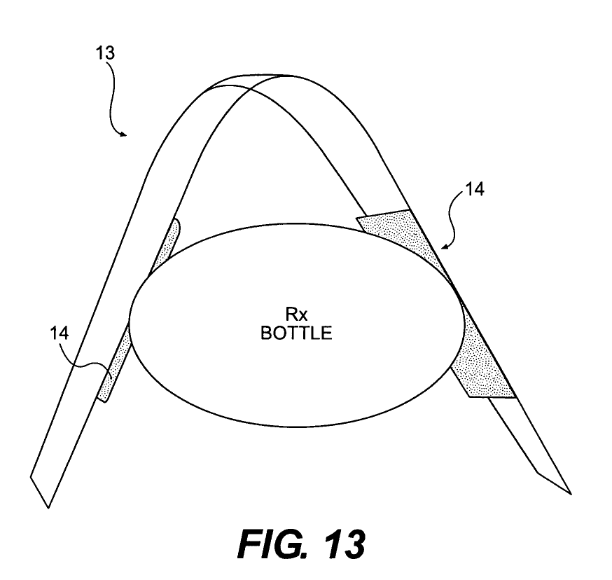

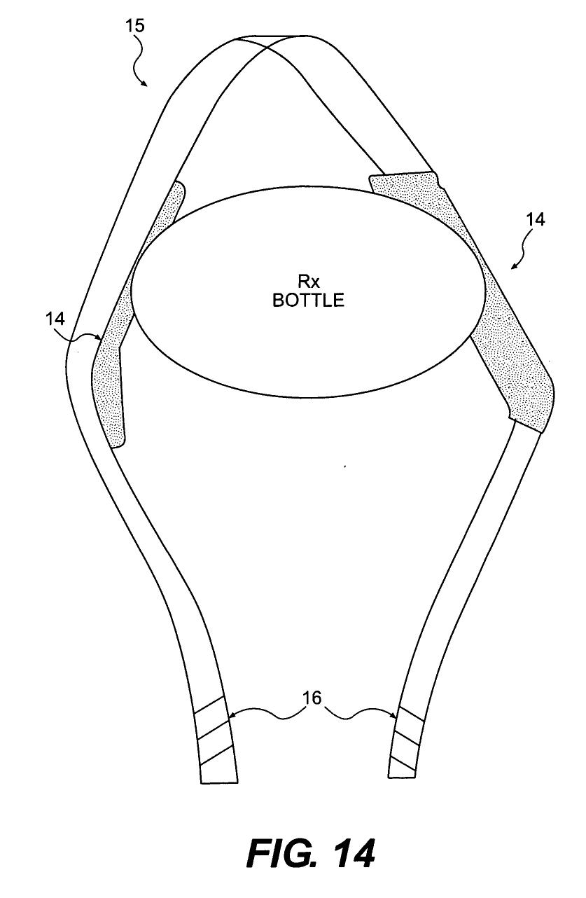

In another embodiment, shown in FIGS. 13, the flexible spatula 13 is shown. It comprises of a flexible material with one or more scraping surfaces 14 that are capable of causing friction. The user will wrap flexible spatula 13 about the used pharmaceutical container so that the one or more scrapping surfaces 14 will be in contact with the label and cause relative motion between the two. The flexible spatula 13 can be made of any suitable material, as can the scraping surfaces 14. Preferably the material for the flexible spatula 13 will allow it to be stiff enough so that the pharmacist can use it to count out pills yet flexible enough to allow it to be wrapped about a pharmaceutical container. The scraping surfaces 14, like the edge 9, can be made of any suitable material and/or structure that can cause the information located on a pharmaceutical container to become illegible. The scrapping surfaces for any embodiment can employ any of the means disclosed for the edge 9 to render a label illegible. In the alternative, the flexible spatula 13 can be of a design such as a slap bracelets. Slap bracelets, also known as Slap Wraps, are discussed in U.S. Pat. No. 6,220,916 B1 and is hereby incorporated by reference. The spatula will be straight until the pharmacist ‘slaps’ it against the side of the pharmaceutical container and causes it to wrap around the container.

In another alternative, you can have a flexible strap 15. The flexible strap 15 can be located on the end (permanently or not) of a spatula handle, any other instrument or not connected to anything. The flexible strap 15 has one or more scraping surfaces 14 (as disclosed above) and grips 16.

Those skilled in the art will now see that certain modifications can be made to the apparatus and methods herein disclosed with respect to the illustrated embodiments, without departing from the spirit of the instant invention. And while the invention has been described above with respect to several embodiments, any element described in reference to any particular embodiment is hereby disclosed to be associated with any other embodiment of the invention. It is understood that the invention is adapted to numerous rearrangements, modifications, and alterations, and all such arrangements, modifications, and alterations are intended to be within the scope of the invention.

What is claimed is:

1. A HIPPA compliance device used by an individual in the distribution of prescription medication having the ability to render labels of used prescription containers illegible, thereby placing the prescription containers in compliance with HIPPA, the HIPPA compliance device comprises:
a handle;
a blade; wherein the blade comprises a spatula and a tool;
wherein said tool comprises an edge; wherein the edge comprises of a means for rendering labels of prescription medication containers illegible;
wherein the blade is capable of movement relative to the handle;
wherein the handle has an opening capable of accepting at least a portion of the tool; wherein the at least a portion of the edge of the tool will be exposed when in an open position and unexposed when in a closed position.

2. The HIPPA compliance device of claim 1, wherein the blade rotates about an axis to place the tool in the open and closed positions.

3. The HIPPA compliance device of claim 1, wherein the means for rendering labels of prescription medication containers illegible comprises a serrated edge, embedded grit, sandpaper, file surface, rasp surface, means to deposit ink, means to deposit water, means to deposit detergent, or any combination thereof.

4. The HIPPA compliance device of claim 3, wherein the edge comprises one or more concave recesses.

5. The HIPPA compliance device of claim 4, wherein the one or more concave recesses have a curvature that corresponds to the curvature of standard pharmaceutical containers.

6. The HIPPA compliance device of claim 1, wherein the tool comprises a tip capable of piercing the seal of a vial; and tip comprises a hook that is capable of ensnaring packing material.

7. The HIPPA compliance device of claim 1, further comprising a locking mechanism, wherein the locking mechanism is capable of locking the tool in an open position, a closed position, one or more positions between the open and closed position or any combination thereof.

8. A HIPPA compliance device used by an individual in the distribution of prescription medication having the ability to render labels of used prescription containers illegible, thereby placing the prescription containers in compliance with HIPPA, the HIPPA compliance device comprises:
a handle; wherein the handle comprises an opening and a connector receptacle;
a blade; wherein the blade comprises a spatula and a tool;
a connector that attaches the blade to the handle, and wherein the blade is capable of rotational movement relative to the handle;
wherein the spatula comprises a material of some length capable of separating medications in pill form; and
wherein the tool comprises an edge, a tip and a hook; wherein the edge is capable of rendering a label of a pharmaceutical container illegible, the tip is capable of puncturing a vial seal and wherein the hook is capable of ensnaring fibrous packing material;
wherein the tool is at least partially received in the opening of the handle when in a closed position and wherein the edge is exposed when in an open position.

9. The HIPPA compliance device of claim 8, wherein the means for rendering labels of prescription medication containers illegible comprises a serrated edge, embedded grit, sandpaper, file surface, rasp surface, means to deposit ink, means to deposit water, means to deposit detergent or any combination thereof.

10. The HIPPA compliance device of claim 9, wherein the edge comprises one or more concave recesses.

11. The HIPPA compliance device of claim 10, wherein the one or more recesses have a curvature that corresponds to the curvature of standard pharmaceutical containers.

12. The HIPPA compliance device of claim 8, wherein the handle further comprises a stop, wherein once the blade encounters the stop when being rotated the tool is in the open position.

13. The HIPPA compliance device of claim 8, further comprising a locking mechanism, wherein the locking mechanism is capable of locking the tool in an open position, a closed position, one or more positions between the open and closed position or any combination thereof.

14. A HIPPA compliance device used by an individual in the distribution of prescription medication having the ability to render labels of used prescription containers illegible, thereby placing the prescription containers in compliance with HIPPA, the HIPPA compliance device comprises:
a strip of flexible material capable of bending about a pharmaceutical container; and
wherein one side of the strip of flexible material has one or more surfaces capable of rendering labels of pharmaceutical containers illegible in response to relative movement between the container and the scraping surface.

15. A HIPPA compliance device according to claim 14, wherein the one or more surfaces comprises a serrated edge, embedded grit, sandpaper, file surface, rasp surface, means to deposit ink, means to deposit water, means to deposit detergent or any combination thereof

16. A HIPPA compliance device according to claim 15, wherein the strip of flexible material comprises a bistable spring body sized in length to coil around the exterior of a pharmaceutical container used to distribute medication to the general public, and having two states, straight or coiled;
and wherein the one or more surfaces are located on the interior of the flexible material when in the coiled state.

17. A HIPPA compliance device according to claim 16, wherein the strip of flexible material comprises of metal, plastic or a combination thereof.

18. A HIPPA compliance device according to claim 15, wherein the one or more of the ends of the flexible is attached to the handle of a pharmaceutical spatula.
